(19) United States
(12) Patent Application Publication
(10) Pub. No.: US 2011/0227536 A1
(43) Pub. Date: Sep. 22, 2011

(54) BATTERY WITH UNIVERSAL CHARGING INPUT

(76) Inventors: Jordan T. Bourilkov, Stamford, CT (US); John Rotondo, Trumbull, CT (US)

(21) Appl. No.: 12/725,615

(22) Filed: Mar. 17, 2010

(51) Int. Cl. H02J 7/00

(52) U.S. Cl. 320/112

(57) ABSTRACT

A battery includes a battery housing containing a rechargeable cell for providing an output voltage and a charging circuit. The charging circuit is coupled to the rechargeable cell and includes a voltage converter to convert an input voltage to the charging circuit to a charging voltage to charge the rechargeable cell.

### BACKGROUND

Battery and fuel cells are electrochemical devices which convert chemical energy into electrical energy by electrochemical oxidation and reduction reactions. In the case of rechargeable system, the battery is recharged by a reversal of the process. This type of reaction involves the transfer of electrons from one material to another through an electric circuit. While the term “battery” is often used, the basic electrochemical unit being referred to is the “cell.” A battery may include one or more cells connected in series or parallel, or both, depending on the desired output voltage and capacity.

Rechargeable batteries can be charged from various sources including an AC source, e.g. using an AC/DC charger, or in a car, e.g. DC/DC charger plugged in the Cigarette Light Adapter (CLA), or using a portable charger. However, charging from different sources require a dedicated charger for each source. The need for multiple chargers increases cost. It is also inconvenient to carry multiple chargers for a single device to be charged from different power sources.

Rechargeable batteries are usually charged from different power sources with different output characteristics.

FIGS. 1A-1C are block diagrams depicting different power sources charging rechargeable batteries in a device 110. In FIG. 1A, the portable device 110 can be charged from an AC source 101, e.g. using an AC/DC adapter 102 and a charging circuit 108a. The device 110 can also be charged in a car, e.g. using DC/DC charger plugged in the Cigarette Light Adapter (CLA) 104 and a charging circuit 108b (FIG. 1B). The device 110 can also be charged from a portable source 106 such as an on-the-go battery using a charging circuit 108c (FIG. 1C). In general, the charging circuits 108a-108c (108 in general) are different from one another and can include different DC/DC converters depending upon the power source being used for charging the rechargeable battery in the device 110. A DC/DC converter 108 may generate several regulated DC voltages, for example, 3.3 V, 5V, 12 V, a supply voltage for a power management controller and optional communications operations involved in the charging process.

### SUMMARY

The need for multiple chargers adds cost to the total system. Further, it is inconvenient to carry multiple chargers for a single device to be charged from different power sources. Multiple charging circuits for charging the same rechargeable battery can be eliminated by embedding the charging circuit with the rechargeable battery in the battery housing or battery pack. This way, the external power supplies are simplified to DC sources producing unregulated output without a charging circuit. On a commercial front, the user pays for only one charging circuit in the battery rather than three external charging circuits in the different charging options. In some implementation, providing the charging circuit in the same unit as the battery eliminates the need for a separate protection circuit as there is no possibility of using a wrong charger.

In one aspect, a battery includes a battery housing containing a rechargeable cell for providing an output voltage and a charging circuit. The charging circuit is coupled to the rechargeable cell and includes a voltage converter to convert an input voltage to the charging circuit to a charging voltage to charge the rechargeable cell.

In another aspect a battery includes a battery housing containing a rechargeable cell for providing an output voltage, and a charging circuit, coupled to the rechargeable cell. The charging circuit includes a digital controller to control the charging circuit, and a voltage converter coupled to the digital controller. The digital converter is configured to convert an input voltage to the charging circuit to provide an output voltage to charge the rechargeable cell.

In another aspect, a rechargeable device includes a device housing containing a battery with an integrated charging circuit. The battery includes a battery housing containing a rechargeable cell for providing an output voltage, and a charging circuit, coupled to the rechargeable cell. The charging circuit includes a digital controller and a voltage converter configured to convert an input voltage to a charging voltage for charging the rechargeable cell.

Implementations include one or more of the following. The battery can include a charging terminal and a discharging terminal both supported by the battery housing, the charging terminal being connected to the charging circuit. The battery can also include a a ground terminal supported by the battery housing, the ground terminal connected to both the rechargeable cell and the charging circuit. The discharging terminal of the battery housing is connected to the discharging terminal of the rechargeable cell. The charging circuit is placed inside the battery housing at such proximity that the IR drop between the charging circuit and the rechargeable cell is less than a threshold value. The rechargeable cell can also include a charging terminal to couple the rechargeable cell to the charging circuit. The voltage converter in the charging circuit can provide a constant voltage or constant current output. The voltage converter in the charging circuit is an analog converter or a digital converter. The battery can include a digital micro-controller unit to control the charging circuit. The input voltage to the battery can be in between 9V and 16V. The input voltage to the battery can also be substantially equal to 12V.

The battery is configured to accept an input voltage provided by a charging pad. Configuration of battery can correspond to a charging pad having a plurality of stripes of alternating polarity. The charging circuit can further include a rectifier to convert an alternating current electrical energy to substantially direct current electrical energy that is fed to the voltage converter.

The device housing houses the battery in a user-accessible or user-inaccessible portion of the device housing. The device can be a mobile telephone. The device can include a removable back cover that houses the battery. The device can include a removable back cover which covers a compartment housing the battery in the device.

Aspects of the invention permit devices, such as mobile phones, notebook computers etc, to have an internal charger. Such a charger that is integrated with either the device or the battery, allows the device to accept charge via a universal charging input. The universal charging input can be made to be compatible with a variety of power sources such as AC power sources, cigarette lighter adapters (CLA), portable charging devices and charging pads. In other words, devices such as mobile phones can be charged from various power sources without requiring different chargers. In some implementations, notebook computers that use custom AC/DC adapters with various voltages and output current limits can be compatible with 12V CLA in different cars, or airplanes, eliminating the need for carrying different chargers.

Rechargeable batteries are usually charged from different power sources with different output characteristics. FIGS. 1A-1C are block diagrams depicting different power sources charging rechargeable batteries in a device 110. Referring to FIG. 1A, the portable device 110 can be charged from an AC source 101, e.g. using an AC/DC adapter 102 and a charging circuit 108a. The device 110 can also be charged in a car, e.g. using DC/DC charger plugged in the Cigarette Light Adapter (CLA) 104 and a charging circuit 108b. The device 110 can also be charged from a portable source 106 such as an on-the-go battery using a charging circuit 108c. In general, the charging circuits 108a-108c (108 in general) are different from one another and can include different DC/DC converters depending upon the power source being used for charging the rechargeable battery in the device 110. A DC/DC converter 108 may generate several regulated DC voltages, for example, 3.3 V, 5V, 12 V, a supply voltage for a power management controller and optional communications operations involved in the charging process.

The details of one or more embodiments of presented battery pack are set forth in the accompanying drawings and the description below. Other features, objects, and advantages will be apparent from the description and drawings, and from the claims.

### DESCRIPTION OF DRAWINGS

FIGS. 1A-1C are schematic block diagrams of conventional (prior art) rechargeable battery charging approaches.

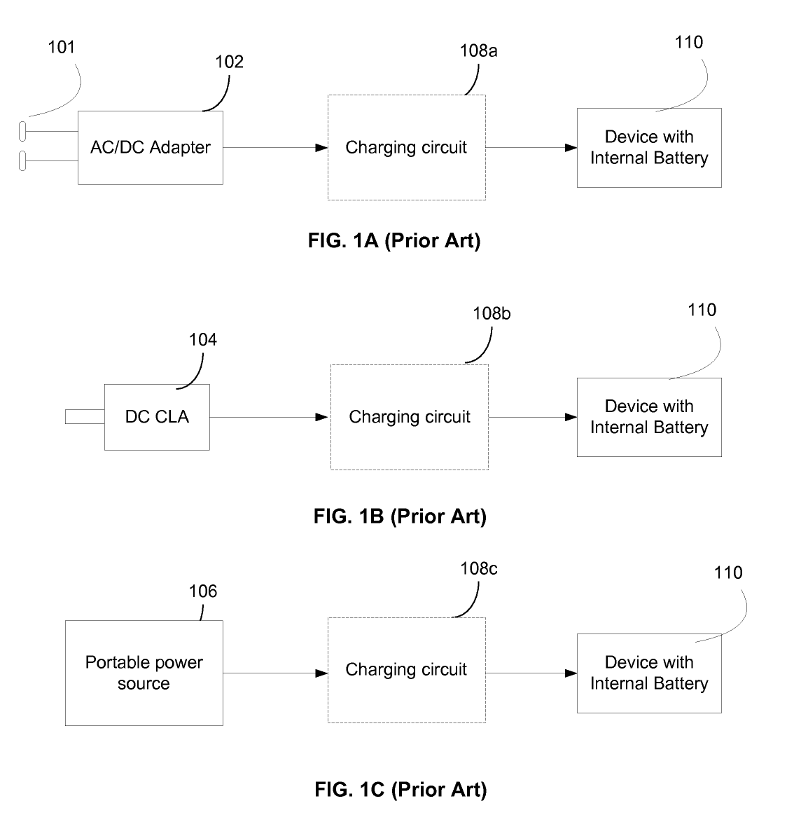

FIGS. 2-3 are schematic diagrams representing batteries with universal charging inputs.

FIG. 4A shows an example of a charging pad.

FIG. 4B shows an example of a device configured to be charged using a charging pad.

FIG. 5 is a schematic diagram of a battery housing.

### DETAILED DESCRIPTION

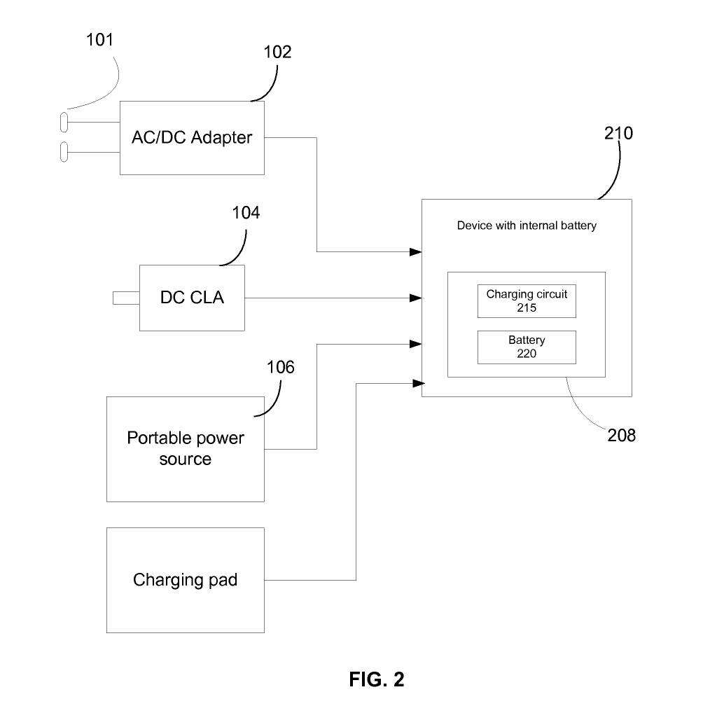

Referring to FIG. 2, a battery pack or battery housing 208 with universal charging input is shown. The battery housing 208 is placed inside a device 210. The battery housing is placed in either a user accessible or user inaccessible portion of the device. For example, in some implementations, the battery housing can be integrated with the removable back cover of a mobile phone. The battery housing can also be placed inside the device, for example in a mobile phone where the battery is concealed by the back cover.

In some implementations, a charging circuit 215, e.g. a charging circuit that accepts a 12V input and outputs a suitable charging voltage/current for a rechargeable battery 220, is embedded with and/or coupled to the rechargeable battery 220 inside the battery housing 208. The charging circuit 215 is configured to accept the input from different sources. The charging circuit 215 is configured to accept unregulated output supplied by the external AC/DC converter 102, which in turn is connected to the AC source 101. The charging circuit 215 is also configured to accept inputs, at different times, from the CLA source 104 or the portable power source 106. The portable power source can be, for example, a 12V on-the-go power battery. The charging circuit may also be configured to accept charging input from a charging pad 107 such as the MYGRID® system from Duracell of Bethel, Conn. or WILDCHARGE® system from PureEnergy Solutions Inc. of Boulder, Colo.

In some implementations, the charging circuit is configured to accept the charging input from other chargers or charging circuits such as a USB port, an inductive charger or a solar charger. The charging circuits is configured to accept different input voltages from the different sources and convert them to a charging voltage/current suitable for charging the battery 220. For example, the CLA source 104 may supply a 12V input while the charging pad may supply a 15V supply. In some implementations, the device 210 has different receptacles or connectors that can be used to couple the device 210 to the various charging sources. The connectors on the device 210, irrespective of their form and type, couple the various input sources to the charging circuit 215.

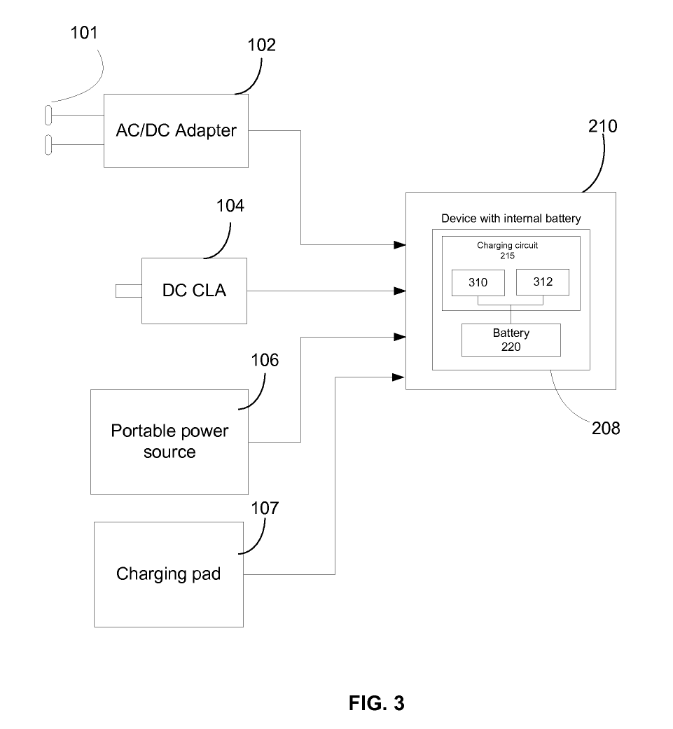

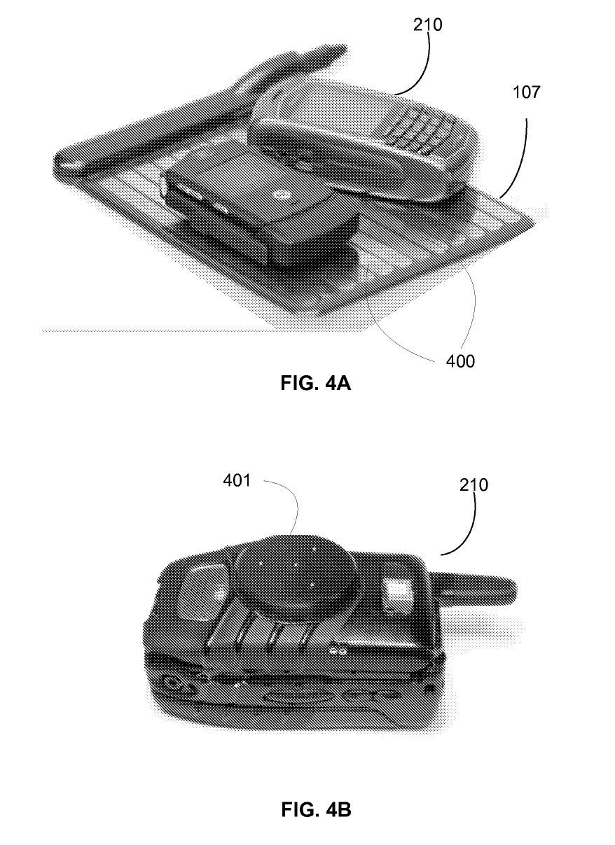

In some implementations, the device 210 is provided with special connectors to accept charging input from a charging pad 107 such as a MYGRID® charging pad. An example of such a charging pad 107 is shown in FIG. 4A. In some implementations, the charging pad 107 includes stripes 400 of alternating polarities. A device 210 can simply be placed on the charging pad 107 in order for it to be charged. In some implementations, the device 210 is modified to accept the charging input from the charging pad 107. An example of such a device 210 is shown in FIG. 4B. In some implementations, the device 210 includes special connectors 401 configured to accept charging input from the stripes 400 of the charging pad 107.

The battery 220 is a combination of one or more rechargeable electro-chemical units or cells that can be recharged electrically, after discharge, to their original condition by passing current through them in the opposite direction to that of the discharge current. If multiple cells are present in the battery 220, the cells can be connected with each other in series or in parallel. In some implementations, a battery 220 (or cell) can include: i) an anode or negative electrode—the reducing or fuel electrode—that gives up electrons to the external circuit and is oxidized during the electrochemical reaction, ii) a cathode or positive electrode—the oxidizing electrode—that accepts electrons from the external circuit and is reduced during the electrochemical reaction, and iii) an electrolyte—the ionic conductor—that provides the medium for transfer of charge, as ions, inside the cell between the anode and cathode. The electrolyte is typically a liquid, such as water or other solvents, with dissolved salts, acids, or alkalis to impart ionic conductivity. In some implementations, the battery 220 can include solid or gaseous electrolytes, that are ionic conductors at the operating temperature of the cell. In some implementations, the rechargeable battery 220, can include Li-Ion cells having graphitic anode material or lithium titanate anode material, and lithiated-iron-phosphate cathode materials adapted to enable fast recharge of rechargeable batteries based on such materials. In general, the battery 220 is a storage device for electric energy and is known also as a “storage battery” or “accumulator.” Rechargeable batteries are sometimes referred to as a secondary battery. Secondary batteries are characterized, in addition to their ability to be recharged, by high power density, high discharge rate, flat discharge curves, and good low-temperature performance.

The device 210 can be any electronic device that uses a battery. For example, the device 210 can include, without limitation, a mobile phone, an electric shaver, an electric toothbrush, a Personal Digital Assistant (PDA), a digital camera, an audio device, a laptop computer, a multimedia device.

Referring now to FIG. 3, the charging circuit 215 can include a charge controller circuit 312. In some implementations, the charge controller 312 is configured to monitor the charging current for different types of secondary or rechargeable batteries, including, for example, cylindrical batteries, prismatic batteries, and button-cell batteries.

One of the most promising secondary batteries include lithium-ion (Li-ion) batteries because of their higher energy density than most other types of rechargeable batteries which results in a compact size and light weight. However, if a Li-ion secondary battery is overcharged, lithium ion separates out as lithium metal at a negative electrode. In the worst case, that the battery can even smoke, ignite, or explode. On the other hand, if the battery is over-discharged, the electrode inside is subject to a small amount of short-circuiting or capacity degradation. When the positive and negative electrodes are short-circuited, an over-current can flow to cause abnormal heating. In order to prevent overcharging, over-discharging and short-circuiting (over-current), the Li-ion secondary battery is generally provided with a protection functionality to monitor these abnormal states and a switch to prevent the abnormal states.

The charge controller circuit 312 is configured to provide such a protection functionality. In such cases, the charge controller circuit 312 can also monitor the cell temperature to prevent temperature extremes. Providing the protection functionality using the charge controller circuit 312, nullifies the need for an external protection board usually required for the Li-ion batteries by providing the same level of protection in the battery pack.

In some implementations, the charge controller circuit 312, or the charging circuit 215 includes a controller that determines the charging current to apply to the battery 220 and causes the determined charging current to be applied the battery 220. The controller causes the charging current to be terminated after a specified or pre-determined time period has elapsed. In some implementations, the controller is configured to cause the charging current to terminate once a pre-determined battery voltage or charge has been reached. In some implementations, determination of the charging current is performed by identifying the capacity and/or type of the battery(s) 220 using, for example, an identification mechanism that communicates data representative of the capacity and/or type of the battery 220.

The controller can be, for example, a microprocessor, a micro-controller Unit (MCU), a digital signal processor (DSP), a programmable logic unit, or a combination thereof. The controller can include volatile and/or non-volatile memory elements configured to store software containing computer instructions to enable general operations of the charging circuit, as well as implementation programs to perform charging operations on the battery 220.

The charge controller circuit 312 can include an analog-to-digital (A/D) converter configured to receive signals from sensors coupled to the battery 220, such as voltage sensors for regulating and controlling the charging operation. The charge controller circuit 312 can further include additional circuitry including but not limited to: a digital-to-analog (D/A) converter, a pulse-width modulator (PWM) that receives digital signals generated by the charge controller circuit 312 and generates in response electrical signals that regulate switching circuitry, such as a buck converter. In some implementations, the charging circuit 215 includes a rectifier configured to convert an alternating current (AC) input to the charging circuit to direct current (DC). The direct current output from the rectifier can then be fed to a DC/DC voltage converter 310.

In some implementations, the charge controller circuit 312 provides optimal DC/DC regulation. The controller can also control additional charging function economically, including constant voltage (CV) and constant current (CC) control, timer, maximum voltage, maximum current and temperature range protections. The controller can also be configured to facilitate communications related to identification of the battery with the device 210 or the external power source if desired. In some implementations, the controller can be reprogrammed for different battery chemistries, sizes, capacities and voltages, as well as for battery pack implementation.

In some implementations, the charging circuit 215 includes a DC/DC converter 310. The converter can be an analog or a digital converter. The converter 310 can accept a range of input voltages and provide the charging voltage required for charging the battery 220. In some implementations, the converter 310 can accept a 12V input (preferably with 9 to 16V input voltage range for CLA compatibility). The DC/DC converter 310 can be a power electronic circuit to provide a regulated output. For example, the converter may provide a stepped-up voltage level, a stepped-down voltage level or a regulated voltage of approximately the same level. The power density of the DC/DC converter 310 may be an order better than the AC/DC converter 102. This allows incorporation in the battery a fairly compact DC/DC converter that provides the battery 220 with a given output characteristics, e.g. CC-CV profile, or simply a maximum voltage and current limit.

In some implementations, the rechargeable battery 220 uses a dual rate charge sequence in which the battery 220 is initially charged at a faster rate for a period of time, and then switched to a slower charging rate (also referred to as “trickle” charge rate) once the battery 220 has reached a predetermined charge level. Rapid charge sequences are terminated by detecting either an inflection in the battery voltage versus time, or inflection in the temperature versus time, or when the battery reaches a certain constant current constant voltage (CC-CV) indicating the onset of trickle charge rate. Li-ion batteries usually are charged by using a CC-CV method in which the battery is charged at a fixed current rate up to a predetermined voltage, and subsequently switched to the trickle charging rate. The predetermined voltage is generally specified by individual manufacturer in connection with the battery capacity and battery cycle life.

In some cases, the battery 220 can sustain the maximum charging current that the DC/DC converter 310 with constant output voltage can provide. In this case, a constant voltage (CV) operation only rather than a constant current/constant voltage (CC/CV) operation can result in faster charging and simplification of the circuit and firmware if available. In such cases, the charging current is limited only by the battery's internal resistance. In some implementations, due to an equalization of the battery and charger, output voltages will taper down over time, providing the fastest possible charging. In case of Li-ion chemistry, there is no need of charge termination, as the maximum charging voltage is selected to be a safe value for continuous operation.

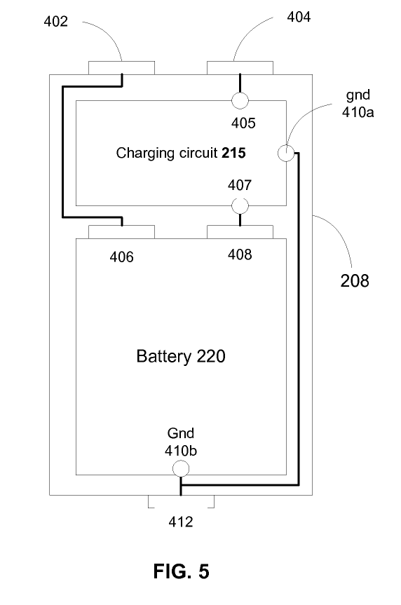

Referring now to FIG. 5, a schematic diagram shows details of the battery housing 208 containing a battery 220 and a charging circuit. In some implementations, the battery housing 208 includes a discharging terminal 402, a charging terminal 404 and a ground terminal 412. The charging circuit 215 includes an input terminal 405, an output terminal 407 and a ground terminal 410a. The charging terminal 404 of the battery housing is connected to the input terminal 405 of the charging circuit 215. The ground terminal 410a of the charging circuit 215 is connected to the ground terminal 412 of the battery housing 208. The battery 220 also includes a charging terminal 408, a discharging terminal 406 and a ground terminal 410b. The charging terminal 408 is connected to the output terminal of the charging circuit 215. In some implementations, the battery 220 and the charging circuit 215 is placed within sufficient proximity of each other such that the IR drop along the connector connecting the terminals 407 and 408 is minimized. In some implementations, the proximity is determined based on a threshold value of the IR drop. The discharging terminal 406 of the battery is connected to the discharging terminal 402 of the battery housing.

Other embodiments are within the scope of the following claims.

What is claimed is:

1. A battery comprising:
a battery housing, containing:
a charging terminal input;
a rechargeable cell for providing an output voltage; and
a charging circuit coupled to the rechargeable cell, the charging circuit comprising:
a voltage converter coupled to the charging terminal input to convert an input voltage at the charging terminal input to a charging voltage to charge the rechargeable cell.

2. The battery of claim 1 further comprises:
a first charging terminal supported by the battery housing, the first charging terminal connected to the charging circuit;
a discharging terminal supported by the battery housing; and
a ground terminal supported by the battery housing, the ground terminal connected to both the rechargeable cell and the charging circuit.

3. The battery of claim 2 wherein the discharging terminal of the battery housing is connected to the discharging terminal of the rechargeable cell.

4. The battery of claim 2 wherein the first charging terminal is configured to accept the input voltage from one of a car adapter, a wall adapter, a USB port, a portable charger, an inductive charger, a solar charger and a charging pad.

5. The battery of claim 1 wherein the charging circuit is placed inside the battery housing at such proximity that the IR drop between the charging circuit and the rechargeable cell is less than a threshold value.

6. The battery of claim 2 wherein the rechargeable cell further comprises a second charging terminal to couple the rechargeable cell to the charging circuit.

7. The battery of claim 1 wherein the voltage converter in the charging circuit provides a constant voltage output.

8. The battery of claim 7 wherein the voltage converter in the charging circuit is one of an analog converter and a digital converter.

9. The battery of claim 1 further comprising a digital micro-controller unit to control the charging circuit.

10. The battery of claim 7 wherein the voltage converter in the charging circuit further provides a constant current output.

11. The battery of claim 1 wherein the input voltage is in between 9V and 16V.

12. The battery of claim 1 wherein the input voltage is substantially equal to 12V.

13. A battery comprising:
a battery housing, containing:
a charging terminal input;
a rechargeable cell for providing an output voltage; and
a charging circuit, coupled to the rechargeable cell, the charging circuit, comprising:
a digital controller to control the charging circuit; and
a voltage converter coupled to the digital controller, configured to convert an input voltage to the charging circuit to provide an output voltage to charge the rechargeable cell.

14. The battery of claim 13 wherein the battery is configured to accept an input voltage provided by a charging pad.

15. The battery of claim 14 wherein configuration of the battery corresponds to a charging pad having a plurality of stripes of alternating polarity.

16. The battery of claim 13 wherein the charging circuit further comprises a rectifier to convert an alternating current electrical energy to substantially direct current electrical energy that is fed to the voltage converter.

17. The battery of claim 13 further comprises:
a first charging terminal supported by the battery housing, the first charging terminal connected to the charging circuit; and
a discharging terminal supported by the battery housing and coupled to a second, different discharge terminal on the rechargeable cell; and
a ground terminal supported by the battery housing, the ground terminal connected to a ground terminal on the rechargeable cell and to the charging circuit.

18. A rechargeable device comprising:
a device housing containing a battery having an integrated charging circuit and a charging terminal input, the battery comprising:
a battery housing, containing:
a rechargeable cell for providing an output voltage; and
a charging circuit coupled to the charging terminal input and the rechargeable cell.

19. The device of claim 18 wherein the charging circuit further comprises
a digital controller; and
a voltage converter configured to convert an input voltage to a charging voltage for charging the rechargeable cell.

20. The device of claim 18 wherein the device housing, houses the battery in a user-inaccessible portion of the device housing.

21. The device of claim 18 wherein the device housing, houses the battery in a user-accessible portion of the device housing.

22. The device of claim 21 wherein the device is a mobile telephone and the mobile telephone includes a removable back cover that houses the battery.

23. The device of claim 21 wherein the device is a mobile telephone and the mobile telephone includes a removable back cover that covers a compartment that houses the battery in the mobile phone.

24. The device of claim 21 wherein the device includes a removable back cover that houses the battery.

25. The device of claim 21 wherein the device includes a removable back cover that covers a compartment that houses the battery in the device.
